(19) United States
(12) Patent Application Publication
(10) Pub. No.: US 2016/0180987 A1
(43) Pub. Date: Jun. 23, 2016

(54) MANUFACTURING METHOD AND MANUFACTURING APPARATUS OF INSULATION COATED CONDUCTING WIRE

(71) Applicant: TOYOTA JIDOSHA KABUSHIKI KAISHA, Toyota-shi (JP)

(72) Inventors: Hideki MANABE, Toyota-shi (JP); Yasuyuki HIRAO, Okazaki-shi (JP)

(73) Assignee: TOYOTA JIDOSHA KABUSHIKI KAISHA, Toyota-shi (JP)

(21) Appl. No.: 14/964,124

(22) Filed: Dec. 9, 2015

(30) Foreign Application Priority Data
Dec. 18, 2014 (JP) 2014-256107

(51) Int. Cl. H01B 13/14

(52) U.S. Cl. CPC H01B 13/143

(57) ABSTRACT

A manufacturing method and apparatus of insulation coated conducting wire insulation coats a conducting wire having a polygonal cross-sectional shape, by extruding molten resin from an annular discharge hole formed between a nipple and a die that encircles the nipple, while passing the conducting wire through a hole provided in the nipple. The annular discharge hole has a polygonal annular shape substantially similar to the cross-sectional shape of the conducting wire.

### INCORPORATION BY REFERENCE

The disclosure of Japanese Patent Application No. 2014-256107 filed on Dec. 18, 2014 including the specification, drawings and abstract is incorporated herein by reference in its entirety.

### BACKGROUND

1. Field of the Invention

Preferred embodiments relate to a manufacturing method and manufacturing apparatus of insulation coated conducting wire.

2. Description of Related Art

Extrusion molding of molten resin is typically used for insulation coating a conducting wire. Two types of such extrusion molding for this insulation coating are known: full extrusion molding and tube extrusion molding. With full extrusion molding, molten resin coated onto a conducting wire inside of a die is extruded through a die hole. That is, an outer shape of the manufactured insulation coated conducting wire is defined by the die hole, so full extrusion molding provides excellent outer dimensional accuracy. However, with full extrusion molding, when attempting to insulation-coat a conducting wire having a polygonal cross-section (i.e., a polygonal sectional shape) (such as flat wire) with a uniform thickness, the thickness of the insulation coating will end up being significantly uneven if the conducting wire twists even slightly inside the die hole.

In contrast, with tube extrusion molding, molten resin is extruded from a discharge hole formed between a nipple and a die that covers the nipple, while the conducting wire passes through a hole in the center portion of the nipple. That is, the molten resin coats the conducting wire after passing through the die separately from the conducting wire. In this way, with tube extrusion molding, the molten resin closely contacts the conducting wire after being extruded. Therefore, even if the conducting wire twists inside the hole in the nipple, the thickness of the insulation coating is able to be more uniform than it is with full extrusion molding.

Japanese Patent Application Publication No. 64-1733 (JP 64-1733 A) describes a method for coating molten resin onto a conducting wire by tube extrusion molding. However, the method described in JP 64-1733 A does not form an insulation coating of a uniform thickness on a conducting wire having a polygonal cross-section.

The inventors discovered the following problems related to a manufacturing method of insulation coated conducting wire, which coats molten resin onto a conducting wire having a polygonal cross-section by tube extrusion molding. FIG. 7 is a sectional view showing a frame format of the manner in which molten resin extruded from a discharge hole is coated onto a conducting wire having a rectangular cross-section, in tube extrusion molding corresponding to related art.

As shown in STEP 1 in FIG. 7, molten resin 50 extruded in a circular sectional shape so as to cover (encircle) a conducting wire 40 is shrunk by reducing the pressure between the conducting wire 40 and the molten resin 50. In this shrinking process, the molten resin 50 first closely contacts the corners of the conducting wire 40, as shown in STEP 2 in FIG. 7. Then, after the molten resin 50 closely contacts the whole conducting wire 40 starting at the corners, the molten resin 50 hardens, as shown in STEP 3 in FIG. 7.

The inventors discovered a problem in which waves occur due to the thickness of the insulation coating formed by the hardening of the molten resin 50 not being uniform particularly on the long sides of the conducting wire 40, as shown in STEP 3 in FIG. 7. This is thought to be because when the molten resin 50 closely contacts the whole conducting wire 40, starting at the corners, the molten resin 50 is unable to shrink uniformly particularly on the long sides of the conducting wire 40. When waves occur in the insulation coating in this way, the number of rejected products in which the thickness of the insulation coating does not meet a predetermined standard (e.g., that there be at least a minimum thickness to ensure insulation all around the conducting wire) increases, so the manufacturing yield decreases. Also, even with acceptable products, if the thickness of the thinnest portion is taken as a reference, the thickness of a portion that is thick due to the waves will be excessive. Therefore, when an insulation coated conducting wire is wound in a coil or the like, or a large number of insulation coated conducting wires are lined up parallel to one another, gaps tend to form, so the space factor of the insulation coated conducting wire will not easily rise.

### SUMMARY

The present disclosure provides a technology for insulation coating a conducting wire having a polygonal cross-section with a more uniform thickness.

A first aspect relates to a manufacturing method of insulation coated conducting wire, which includes insulation coating a conducting wire having a polygonal cross-sectional shape, by extruding molten resin from an annular discharge hole formed between a nipple and a die that covers the nipple, while passing the conducting wire through a hole provided in the nipple. The annular discharge hole is faulted having a polygonal annular shape substantially similar to the cross-sectional shape of the conducting wire.

With this manufacturing method, the discharge hole for extruding the molten resin is formed in a polygonal annular shape substantially similar to the cross-sectional shape of the conducting wire. Therefore, the extruded molten resin is formed in a polygonal annular shape substantially similar to the cross-sectional shape of the conducting wire. Also, the extruded molten resin shrinks and closely contacts the whole conducting wire almost simultaneously. As a result, the thickness of the insulation coating is able to be more uniform.

A corner of the discharge hole may extend out toward an outside, such that a width of the discharge hole becomes wider than a width of a straight portion of the discharge hole. This kind of structure enables a difference between the thickness of the insulation coating formed on the straight portion of the conducting wire and the thickness of the insulation coating formed on the corner of the conducting wire to be reduced, thus enabling the thickness of the insulation coating to be more uniform.

Also, the conducting wire may be a flat wire, the discharge hole may be formed in a rectangular annular shape, and a width of a straight portion on a vertically upper side of the discharge hole may be formed wider than a width of the straight portion on a vertically lower side of the discharge hole. This kind of structure enables a difference between the thickness of the insulation coating formed on a long side on a vertically upper side of the conducting wire and the thickness of the insulation coating fanned on a long side on a vertically lower side of the conducting wire to be reduced, thus enabling the thickness of the insulation coating to be more uniform.

Furthermore, the conducting wire may be formed by twisting a plurality of wires together. This kind of structure enables loss due to eddy currents to be reduced.

A second aspect relates to a manufacturing apparatus of insulation coated conducting wire, which includes a nipple having a hole through which a conducting wire having a polygonal cross-sectional shape is passed, and a die that covers (encircles) the nipple, an annular discharge hole being provided between the nipple and the die, the annular discharge hole having a polygonal annular shape substantially similar to the cross-sectional shape of the conducting wire. The hole in the nipple also has a shape similar to the cross-sectional shape of the conducting wire, and thus also has a shape similar to the shape of the annular discharge hole.

With this manufacturing apparatus, the discharge hole for extruding the molten resin is formed in a polygonal annular shape substantially similar to the cross-sectional shape of the conducting wire. Therefore, the extruded molten resin is formed in a polygonal annular shape substantially similar to the cross-sectional shape of the conducting wire. Also, the extruded molten resin shrinks and closely contacts the whole conducting wire almost simultaneously. As a result, the thickness of the insulation coating is able to be more uniform.

The disclosed embodiments thus make it possible to insulation coat a conducting wire having a polygonal cross-section with a more uniform thickness.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a sectional view showing a frame format of a manufacturing apparatus of insulation coated conducting wire according to a first example embodiment;

FIG. 2 is a perspective view of a die and a nipple shown in FIG. 1;

FIG. 3 is a front view of the die and the nipple shown in FIG. 1;

FIG. 4 is a sectional view showing a frame format of the manner in which molten resin extruded from a discharge hole coats a conducting wire having a rectangular cross-section;

FIG. 5 is a front view of the die and the nipple according to a second example embodiment;

FIG. 6 is a front view of the die and the nipple according to a third example embodiment; and

FIG. 7 is a sectional view showing a frame format of the manner in which molten resin extruded from a discharge hole is coated onto a conducting wire having a rectangular cross-section, in tube extrusion molding according to related art.

### DETAILED DESCRIPTION OF EMBODIMENTS

Hereinafter, specific example embodiments will be described in detail with reference to the accompanying drawings. However, the invention is not limited to these example embodiments. Also, the description and the drawings are simplified as appropriate for clarity.

### First Example Embodiment

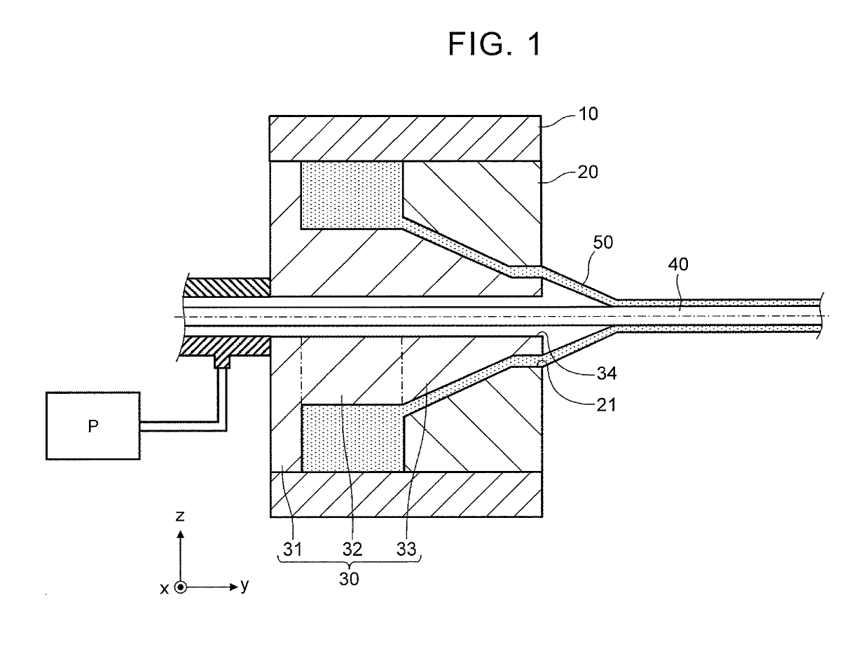

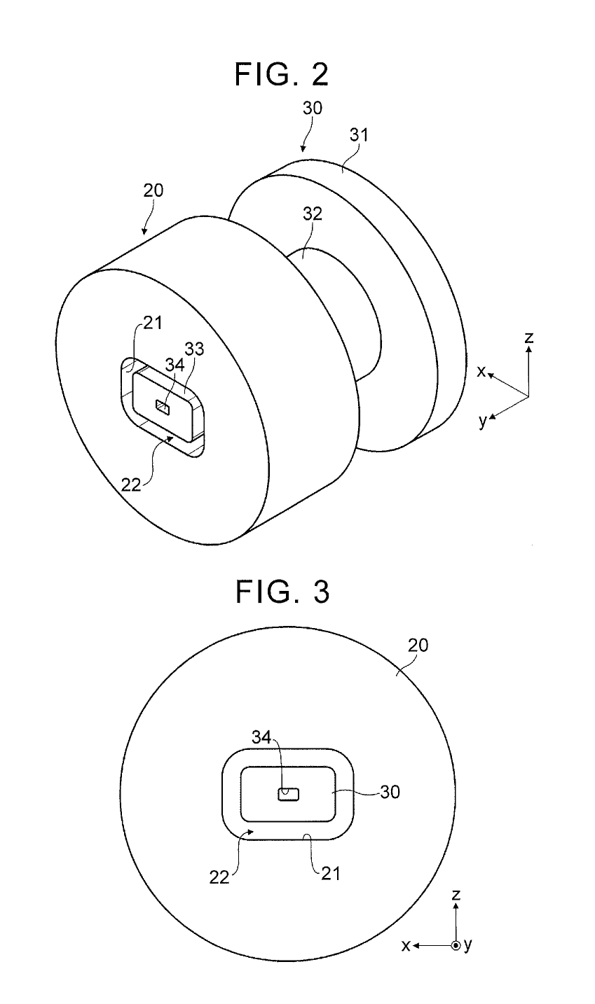

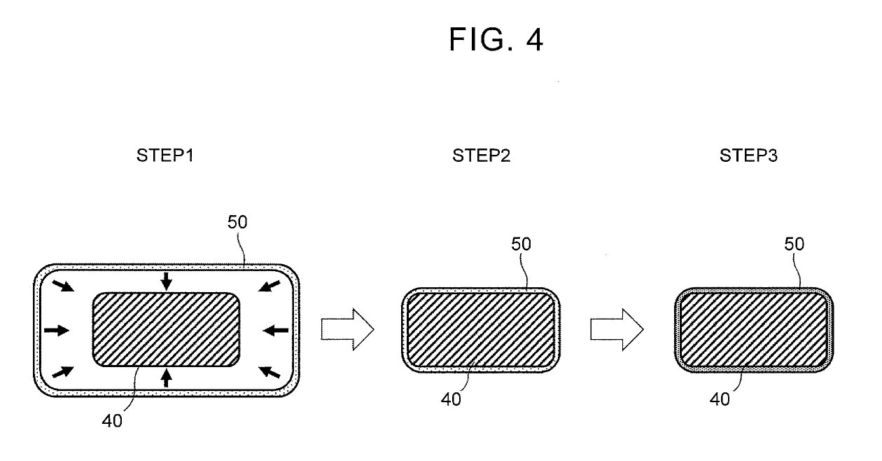

A manufacturing apparatus of insulation coated conducting wire and a manufacturing method of insulation coated conducting wire using this manufacturing apparatus, according to a first example embodiment, will be described with reference to FIGS. 1 to 3. FIG. 1 is a sectional view showing a frame format of a manufacturing apparatus of insulation coated conducting wire according to the first example embodiment. FIG. 2 is a perspective view of a die 20 and a nipple 30 shown in FIG. 1. FIG. 3 is a front view of the die 20 and the nipple 30 shown in FIG. 1. The manufacturing apparatus of insulation coated conducting wire according to the first example embodiment is designed to continuously manufacture an insulation coated conducting wire by performing tube extrusion molding on a conducting wire having a polygonal cross-section. In this example embodiment, the conducting wire 40 is a flat wire having a rectangular cross-section.

Naturally, a right-handed xyz coordinate system shown in FIGS. 1 to 3 is for descriptive purposes in order to illustrate the positional relationship of the constituent elements. Normally, the manufacturing apparatus of insulation coated conducting wire is placed on a horizontal floor surface or the like, such that a z-axis plus direction in FIGS. 1 to 3 is the vertically upward direction. Therefore, in FIGS. 1 to 3, the z-axis plus direction is the vertically upward direction, and the xy plane is a horizontal plane.

As shown in FIG. 1, the manufacturing apparatus of insulation coated conducting wire according to the first example embodiment includes a cross head 10, the die 20 and the nipple 30 that are mounted to the cross head 10, and a pressure-reducing pump P. The manufacturing apparatus of insulation coated conducting wire according to this example embodiment insulation coats the conducting wire 40 by tube extrusion molding. That is, molten resin 50 is extruded from an annular discharge hole 22 formed between the nipple 30 and the die 20 that covers (encircles) the nipple 30, while the conducting wire 40 passes through a through-hole 34 provided in the nipple 30. That is, the molten resin 50 coats the conducting wire 40 after passing through the die 20 separately from the conducting wire 40. In this way, with tube extrusion molding, the molten resin 50 closely contacts the conducting wire 40 after being extruded. Therefore, even if the conducting wire 40 twists inside the through-hole 34 in the nipple 30, the thickness of the insulation coating is able to be more uniform than it is with full extrusion molding.

As shown in FIG. 1, the die 20 and the nipple 30 are mounted to the cross head 10, and the molten resin 50 is filled into a gap between the die 20 and the nipple 30. Here, the molten resin 50 is continuously pressed in by a screw or the like via an opening provided in the cross head 10, not shown,

The die 20 is a circular cylindrical member that has a central axis parallel to the y-axis, as shown in FIG. 2. A through-hole 21 for accommodating a truncated cone portion 33 of the nipple 30 is formed in the center portion of the die 20, as shown in FIGS. 1 and 2. Here, the shape of the through-hole 21 in a tip end surface (an end surface on the y-axis direction plus side) of the die 20 is formed in a rectangular shape matching the end surface shape of the truncated cone portion 33 of the nipple 30.

The through-hole 34 having a rectangular cross-section for guiding the conducting wire 40 is provided extending in the y-axis direction, as shown in FIG. 1, in the center portion of the nipple 30. Also, for descriptive purposes, the nipple 30 may be divided into a flange portion 31, a circular cylindrical portion 32, and the truncated cone portion 33. The flange portion 31 is a disk-shaped portion provided on a rear end (a y-axis minus side end portion), and has an outer diameter equivalent to that of the die 20. The circular cylindrical portion 32 is a circular cylindrical portion that has an outer diameter smaller than that of the die 20. The truncated cone portion 33 is a portion that has a generally truncated cone shape in which the outer diameter gradually becomes smaller in the y-axis plus direction from the circular cylindrical portion 32, and is housed in the through-hole 21 in the die 20. Here, the end surface shape of the truncated cone portion 33 is formed in a rectangular shape, not a circular shape, matching the sectional shape of the conducting wire 40, i.e., the through-hole 34, as shown in FIG. 2.

The molten resin 50 is retained between the die 20 and the flange portion 31 of the nipple 30, i.e., around the circular cylindrical portion 32 of the nipple 30, as shown in FIG. 1. The retained molten resin 50 passes through the gap between the die 20 and the truncated cone portion 33 of the nipple 30, and is extruded from the discharge hole 22 (see FIGS. 2 and 3) formed between the tip end surfaces (the end surfaces on the y-axis direction plus side) of these. Here, because the shape of the through-hole 21 in the tip end surface of the die 20 and the end surface shape of the truncated cone portion 33 of the nipple 30 are both rectangular, the discharge hole 22 is formed in a rectangular annular shape, as shown in FIGS. 2 and 3. That is, the discharge hole 22 is formed in a polygonal annular shape, i.e., a rectangular annular shape, substantially similar to the sectional shape of the conducting wire 40. This kind of structure makes it possible to insulation coat the rectangular conducting wire 40 with a uniform thickness. The specific reason for this will be described later.

The pressure-reducing pump P is provided on a rear end surface (the y-axis direction minus side end surface) of the nipple 30, and reduces the pressure inside the through-hole 34 in the nipple 30 that the conducting wire 40 passes through. That is, the pressure in a space that is covered (encircled) by the molten resin 50 extruded from the die 20 and has the conducting wire 40 as its central axis is reduced. Therefore, the extruded molten resin 50 closely contacts the conducting wire 40.

The conducting wire 40 is not particularly limited, but may be made of metal material having high conductivity, such as copper, aluminum, or an alloy having copper and/or aluminum as the main components, for example. In this example embodiment, the sectional shape of the conducting wire 40 is rectangular, but it may also be other polygonal shapes. Here, a plurality of the conducting wires 40 are preferably lined up along a conducting wire axis with no gaps therebetween when wound in a coil shape. Therefore, aside from rectangular, the sectional shape of the conducting wire 40 may also be equilateral-triangular, or regular hexagonal or the like. One example of the sectional dimensions of the conducting wire 40 having a rectangular sectional shape are approximately 2 mm×3.5 mm.

The conducting wire 40 is not limited to a single wire, and may also be a wire assembly formed by twisting a plurality of wires together, that has been machined to have a polygonal sectional shape. Using a wire assembly makes it possible to reduce loss from eddy currents, compared to when a single wire is used.

Further, the conducting wire 40 passes through the nipple 30 in a state preheated to approximately 150 to 300° C., for example. With a wire assembly, twisting tends to occur inside the through-hole 34 of the nipple 30 due to this preheating. However, with the manufacturing apparatus of insulation coated conducting wire according to this example embodiment, tube extrusion molding is used, so the molten resin 50 that is extruded closely contacts with this twisted conducting wire 40 later. Therefore, the thickness of the insulation coating is able to be uniform.

The type of molten resin 50 is not particularly limited. For example, PPS resin, PFA resin, or PEEK resin or the like may be used. The preheating temperature of the conducting wire 40 described above may be changed appropriately according to the type of the molten resin 50. The thickness of the insulation coating formed by the molten resin 50 hardening is preferably as thin as possible while still being able to ensure insulation. The thickness of the insulation coating is approximately 60 to 120 μm, for example.

Next, the reason that the conducting wire 40 is able to be insulation coated with a uniform thickness in the manufacturing method of insulation coated conducting wire according to the example embodiment will be described with reference to FIG. 4. FIG. 4 is a sectional view showing a frame format of the manner in which the molten resin 50 extruded from the discharge hole 22 coats the conducting wire 40 having a rectangular cross-section.

As shown in STEP 1 in FIG. 4, the molten resin 50 that has been extruded in a rectangular sectional shape so as to cover (encircle) the conducting wire 40 is shrunk by pressure reduction. Here, the discharge hole 22, i.e., the extruded molten resin 50, is formed in a rectangular annular shape substantially similar to the sectional shape of the conducting wire 40. Therefore, the molten resin 50 that has shrunk evenly comes into close contact with the whole conducting wire 40 almost simultaneously, as shown in STEP 2 in FIG. 4. Then, as shown in STEP 3 in FIG. 4, the insulation coating is formed by hardening of the molten resin 50 that closely contacts the whole conducting wire 40 with a uniform thickness.

On the other hand, with the related art shown in FIG. 7, the extruded molten resin 50 is formed in a circular annular shape. Therefore, the molten resin 50 first contacts the corners of the conducting wire 40, and then starting with these corners, the molten resin 50 contacts the whole conducting wire 40. At this time, the molten resin 50 is unable to shrink uniformly on the long sides of the conducting wire 40 in particular, so the thickness of the insulation coating formed by the hardened molten resin 50 is not uniform, such that waves are created in the insulation coating, which is problematic. Also, the thickness of the insulation coating on the long sides of the conducting wire 40 in particular becomes thicker than the thickness of the insulation coating at the corners of the conducting wire 40 due to the insulation coating shrinking after contacting the corners, which is also problematic.

In contrast, with the manufacturing method of insulation coated conducting wire according to this example embodiment, the discharge hole 22, i.e., the extruded molten resin 50, is formed in a rectangular annular shape substantially similar to the sectional shape of the conducting wire 40, as shown in STEP 1 in FIG. 4. Therefore, the molten resin 50 that has shrunk uniformly closely contacts the whole conducting wire 40 almost simultaneously, as shown in STEP 2 in FIG. 4. As a result, waves in the insulation coating on the long sides of the conducting wire 40 are able to be inhibited, so the thickness of the insulation coating is able to be uniform. Also, the difference between the thickness of the insulation coating formed on the long sides of the conducting wire 40 and the thickness of the insulation coating formed on the corners of the conducting wire 40 is also able to be reduced. Because the thickness of the insulation coating is uniform, when a coil or the like is formed by winding the insulation coated conducting wire or when many insulation coated conducting wires are lined up in parallel, gaps tend not to form, so the space factor of the insulation coated conducting wire is able to be improved.

### Second Example Embodiment

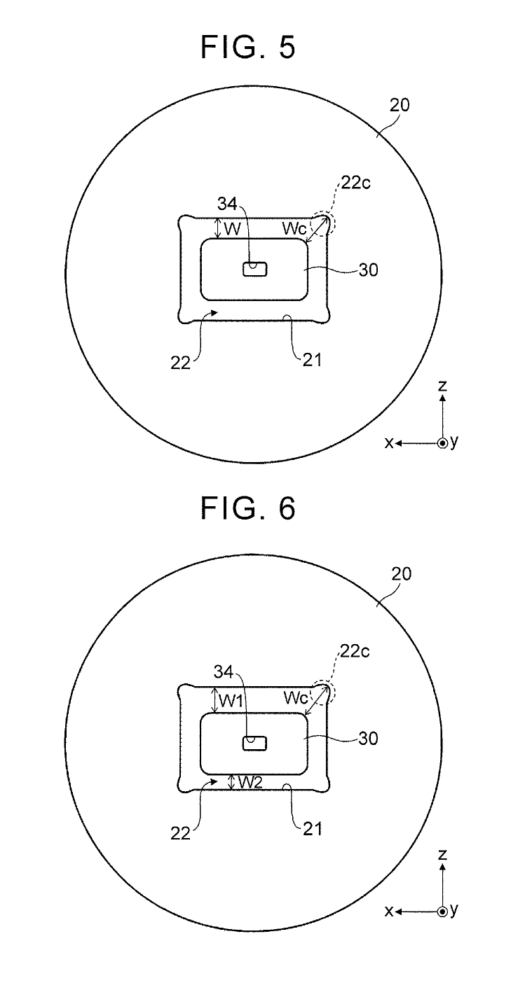

Next, a manufacturing apparatus of insulation coated conducting wire and a manufacturing method of insulation coated conducting wire using this manufacturing apparatus, according to a second example embodiment, will be described with reference to FIG. 5. FIG. 5 is a front view of the die 20 and the nipple 30 according to the second example embodiment. Here, as shown in FIG. 5, the discharge hole 22 for extruding the molten resin 50 is formed between the die 20 and the nipple 30, just as in FIG. 3.

As described above, with the manufacturing method of insulation coated conducting wire according to the first example embodiment, the difference between the thickness of the insulation coating formed on the long sides of the conducting wire 40 and the thickness of the insulation coating formed on the corners of the conducting wire 40 is also able to be reduced. However, the thickness of the molten resin 50 formed on the corners of the conducting wire 40 may end up becoming thinner due to surface tension when the molten resin 50 hardens.

Therefore, with the manufacturing method of insulation coated conducting wire according to the second example embodiment, an extended portion 22c that extends toward the outside is formed at each of the corners of the discharge hole 22 formed between the die 20 and the nipple 30. Here, the extended portion 22c of the discharge hole 22 may also be referred to as a recessed portion provided at the corners of the through-hole 21 of the die 20.

In this way, with the manufacturing method of insulation coated conducting wire according to this example embodiment, a width We of a corner is made wider than a width W of a straight portion of the discharge hole 22, taking into account the effect of surface tension of the molten resin 50 formed on the corners of the conducting wire 40 described above. That is, the thickness of the molten resin 50 formed on the corners of the conducting wire 40 is made thicker than the thickness of the molten resin 50 formed on the straight portions of the conducting wire 40. With this kind of structure, the difference between the thickness of the insulation coating formed on the long sides of the conducting wire 40 and the thickness of the insulation coating formed on the corners of the conducting wire 40 is able to be even further reduced, so the thickness of the insulation coating is able to be even more uniform. The other structure is that same as that of the manufacturing method of insulation coated conducting wire according to the first example embodiment, so a description thereof will be omitted.

### Third Example Embodiment

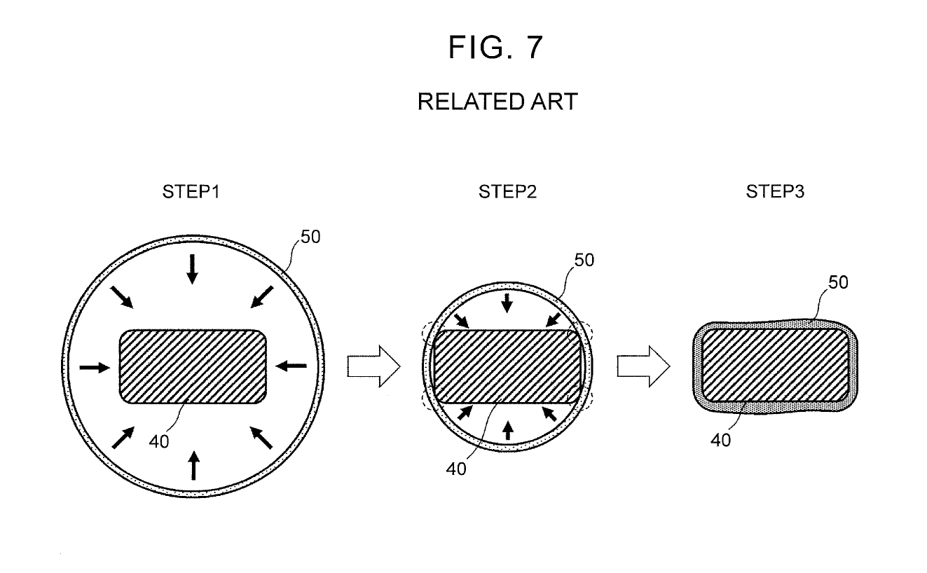

Next, a manufacturing apparatus of insulation coated conducting wire and a manufacturing method of insulation coated conducting wire using this manufacturing apparatus, according to a third example embodiment, will be described with reference to FIG. 6. FIG. 6 is a front view of the die 20 and the nipple 30 according to the third example embodiment. Here, as shown in FIG. 6, the discharge hole 22 for extruding the molten resin 50 is formed between the die 20 and the nipple 30, just as in FIG. 3.

With the manufacturing method of insulation coated conducting wire according to the first and second example embodiments, the molten resin 50 formed on the long side on the vertically upper side (the z-axis direction plus side) of the conducting wire 40 runs down to the vertically lower side (the z-axis direction minus side) by gravity until it hardens. Therefore, the thickness of the insulation coating formed on the long side on the vertically upper side of the conducting wire 40 becomes thinner. On the other hand, the molten resin 50 that has run down from the vertically upper side until it hardens is added to the molten resin 50 formed on the long side on the vertically lower side (the z-axis direction minus side) of the conducting wire 40. Therefore, the thickness of the insulation coating formed on the long side on the vertically lower side of the conducting wire 40 becomes thicker. That is, the thickness of the insulation coating formed on the long side on the vertically upper side of the conducting wire 40 becomes thinner than the thickness of the insulation coating formed on the long side on the vertically lower side of the conducting wire 40, which is problematic.

Thus, with the manufacturing method of insulation coated conducting wire according to the third example embodiment, a width W1 of the straight portion on the vertically upper side of the discharge hole 22 is made wider than a width W2 of the straight portion on the vertically lower side of the discharge hole 22, taking into account the effect of gravity on the molten resin 50 described above. That is, the thickness of the molten resin 50 formed on the long side on the vertically upper side of the conducting wire 40 is made thicker than the thickness of the molten resin 50 formed on the long side on the vertically lower side of the conducting wire 40. This kind of structure makes it possible to reduce the difference between the thickness of the insulation coating formed on the long side on the vertically upper side of the conducting wire 40, and the thickness of the insulation coating formed on the long side on the vertically lower side of the conducting wire 40, and thus enables the thickness of the insulation coating to be more uniform. The other structure is the same as that of the manufacturing method of insulation coated conducting wire according to the second example embodiment, so a description thereof will be omitted.

The invention is not limited to the example embodiments described above, and may be modified as appropriate without departing from the spirit of the invention.

What is claimed is:

1. A manufacturing method of insulation coated conducting wire, the method comprising:
insulation coating a conducting wire having a polygonal cross-sectional shape, by extruding molten resin from an annular discharge hole formed between a nipple and a die that encircles the nipple, while passing the conducting wire through a hole provided in the nipple,
wherein the annular discharge hole has a polygonal annular shape substantially similar to the cross-sectional shape of the conducting wire.

2. The manufacturing method according to claim 1, wherein
a corner of the annular discharge hole extends out toward an outside, such that a width of the corner of the annular discharge hole is wider than a width of a straight portion of the annular discharge hole.

3. The manufacturing method according to claim 1, wherein
the conducting wire is a flat wire;
the annular discharge hole has a rectangular annular shape; and
a width of a first straight portion of the annular discharge hole on a vertically upper side of the annular discharge hole is wider than a width of a second straight portion of the annular discharge hole on a vertically lower side of the annular discharge hole.

4. The manufacturing method according to claim 1, wherein
the conducting wire includes a plurality of wires twisted together.

5. The manufacturing method according to claim 1, wherein
the conducting wire is insulation coated by reducing a pressure in a space between the conducting wire and the molten resin.

6. The manufacturing method according to claim 1, wherein the hole provided in the nipple has a polygonal shape substantially similar to the polygonal cross-sectional shape of the conducting wire.

7. A manufacturing apparatus of insulation coated conducting wire, the apparatus comprising:
a nipple having a hole through which a conducting wire having a polygonal cross-sectional shape is passed; and
a die that encircles the nipple, an annular discharge hole provided between the nipple and the die, the annular discharge hole having a polygonal annular shape substantially similar to the cross-sectional shape of the conducting wire.

8. The manufacturing apparatus according to claim 7, wherein
a corner of the annular discharge hole extends out toward an outside, such that a width of the corner of the annular discharge hole is wider than a width of a straight portion of the annular discharge hole.

9. The manufacturing apparatus according to claim 7, wherein
the annular discharge hole has a rectangular annular shape; and
a width of a first straight portion of the annular discharge hole on a vertically upper side of the annular discharge hole is wider than a width of a second straight portion of the annular discharge hole on a vertically lower side of the annular discharge hole.

10. The manufacturing apparatus according to claim 7, further comprising:
a pump that reduces a pressure in a space inside the hole of the nipple.

11. The manufacturing apparatus according to claim 7, wherein the hole of the nipple has a polygonal shape substantially similar to the polygonal cross-sectional shape of the conducting wire.
